(19) United States
(12) Patent Application Publication
(10) Pub. No.: US 2025/0364620 A1
(43) Pub. Date: Nov. 27, 2025

(54) TRACTION BATTERY FOR A MOTOR VEHICLE AND METHOD FOR PRODUCING A TRACTION BATTERY

(71) Applicant: AUDI AG, Ingolstadt (DE)

(72) Inventors: Marc GORMANNS, Erlenbach (DE); Sebastian KUNZE, Dietfurt an der Altmühl (DE); Erich LEHNER, Bad Friedrichshall (DE); Daniel SCHMID, Stammham (DE); Michael SCHÜßLER, Neckarsulm (DE); Diana WALENWEIN, lngolstadt (DE)

(73) Assignee: AUDI AG, Ingolstadt (DE)

(21) Appl. No.: 19/214,561

(22) Filed: May 21, 2025

(30) Foreign Application Priority Data
May 24, 2024 (DE) 102024114608.7

(51) Int. Cl. H01M 10/617; B60K 11/02; B60L 50/64; H01M 10/625; H01M 10/63; H01M 10/647; H01M 10/6554; H01M 10/656; H01M 50/209; H01M 50/249

(52) U.S. Cl. CPC H01M 10/617; B60K 11/02; H01M 10/625; H01M 10/63; H01M 10/647; H01M 10/6554; H01M 10/656; H01M 50/209; H01M 50/249; B60L 50/64; H01M 2220/20

(57) ABSTRACT

A traction battery for a motor vehicle, including a cell module having a battery cell arrangement and a temperature control device for temperature control of the battery cell arrangement. The temperature control device has a temperature control element having at least one fluid channel, which is connected to the battery cell arrangement by a holding frame of the cell module, is inserted together with the battery cell arrangement into a battery housing of the traction battery and is thermally coupled to the battery cell arrangement via a heat conducting conductor.

### FIELD

The invention relates to a traction battery for a motor vehicle, comprising a cell module having a battery cell arrangement and a temperature control device for temperature control of the battery cell arrangement. The invention further relates to a method for producing a traction battery.

### BACKGROUND

For example, document US 2023/0198047 A1 is known from the prior art. This describes a cell arrangement comprising: a plurality of battery cells; and a pad disposed between the plurality of battery cells, wherein the pad has a first pad surface and a second pad surface arranged opposite the first pad surface, wherein the pad comprises: an elastic pad body; and a heat conduction member coupled to the pad body and connected to an edge of the pad, wherein the heat conduction member is heat conducting, wherein the pad body forms at least a portion of the first pad surface, and the pad body forms at least a portion of the second pad surface.

Further prior art is known from EP 4 287 329 A1, EP 4 270 599 A1 and CN 219575748 U1.

### SUMMARY

It is an object of the invention to propose a traction battery for a motor vehicle which has advantages over known traction batteries, in particular enabling effective temperature control of the battery cell arrangement of the cell module even with a high energy storage density of the traction battery.

This is achieved according to the invention with a traction battery for a motor vehicle. It is provided that the temperature control device has a temperature control element having at least one fluid channel, which is connected to the battery cell arrangement by means of a holding frame of the cell module, is inserted together with the battery cell arrangement into a battery housing of the traction battery and is thermally coupled to the battery cell arrangement via a heat conducting means.

It is pointed out that the exemplary embodiments explained in the description are not limiting; rather, any variations of the features disclosed in the description, the claims and the figures can be implemented.

The traction battery is preferably part of the motor vehicle, but can of course also be present separately from it, in particular before the traction battery is fitted on or in the motor vehicle. The traction battery is intended and designed for the temporary storage of electrical energy for a drive device of the motor vehicle. The drive device is used to drive the motor vehicle and thus to provide a drive torque that is for driving the motor vehicle. To provide the drive torque, the drive device has at least one drive unit which is designed as an electric traction machine that is electrically connected to the traction battery.

The electrical energy stored in the traction battery is thus used to drive at least temporarily the motor vehicle, thus to provide a drive torque intended to drive the motor vehicle by means of the drive device of the drive unit. Conversely, it can be provided that electrical energy provided by the drive device is temporarily stored in the traction battery.

The traction battery has the battery cell arrangement, which in turn has at least one battery cell, i.e. in particular exactly one battery cell or multiple battery cells. If in this description the battery cell or the at least one battery cell is mentioned, the statements are always equivalent. Explanations regarding the at least one battery cell are applicable to the battery cell and vice versa. If the battery cell arrangement has a plurality of battery cells, the explanations for the battery cell or the at least one battery cell are transferable to the battery cells, in particular to each of the plurality of battery cells. The battery cell is preferably a prismatic cell or a pouch cell.

The battery cell arrangement together with the temperature control device forms the cell module of the traction battery. The cell module is, for example, a component of a battery module of the traction battery, which in addition to the cell module preferably has end plates and/or a clamping device. The battery module can have one or more cell modules. In particular, the cell modules of the battery module are designed identically, so that the statements in this description for the cell module are applicable to each of the plurality of cell modules of the battery module. The cell module or the plurality of cell modules are arranged between the end plates and clamped by means of the clamping device to form the battery module.

The end plates are, for example, part of a battery module housing. The end plates accommodate the cell module or the cell modules, in particular the battery cell arrangement or the battery cell arrangements of the cell modules, between them. In this respect, the end plates are arranged on opposite sides of the cell module or cell modules. Preferably, the battery cell arrangement is cuboid-shaped or at least approximately cuboid-shaped.

If the battery cell arrangement has multiple battery cells, these are preferably electrically interconnected. For this purpose, the battery cells are arranged, for example, in such a way that their electrical connections are arranged on the same side and/or face each other. The connections are, for example, electrically connected to one another by means of a plurality of busbars, which are preferably also electrically connected to electrical connections of the cell module and/or the battery module. In other words, the battery cells of the cell module are electrically connected to the terminals via the busbars.

Preferably, the traction battery has a battery housing in which a battery module receptacle is configured, which is provided and configured to receive the battery module or a plurality of battery modules. During the production of the traction battery, the battery module is inserted into the battery module receptacle. Preferably, not only a single battery module is arranged in the battery housing, but rather multiple battery modules are introduced into the battery housing. In such an embodiment, the battery housing has a battery module receptacle which is designed to accommodate multiple battery modules, or multiple battery module receptacles.

During operation of the traction battery, heat is generated in the battery cell arrangement, which must be dissipated from it, or heat must be supplied to reach a certain temperature of the battery cell arrangement. Accordingly, the traction battery or cell module has the temperature control device by means of which the battery cell arrangement is at least temporarily tempered. With the help of the temperature control device, heat is at least temporarily removed from the battery cell arrangement and/or heat is supplied to the battery cell arrangement using the temperature control device.

The temperature control device is usually part of the battery housing, in particular a base plate of the battery housing. During assembly of the traction battery, the cell module is inserted into the battery housing in such a way that the battery cell arrangement is subsequently connected to the temperature control device or the base plate in a heat-transfer manner. To ensure a reliable connection of the battery cell arrangement to the temperature control device, the heat transfer medium can be used. This is sometimes also referred to as a “gap filler”. However, such a design of the traction battery only allows the heat to be dissipated or supplied over a comparatively small region of the battery cell arrangement. Accordingly, achieving a uniform temperature distribution in the battery cell arrangement is challenging.

For this reason, the invention provides that the temperature control device has the temperature control element. At least one fluid channel is formed in the temperature control element, through which a fluid flows at least temporarily to control the temperature the battery cell arrangement. In other words, the fluid is supplied to the fluid channel for temperature control of the battery cell arrangement at least temporarily on the one hand and removed on the other hand. In particular, the fluid channel is fluidically connected to a fluid circuit. The temperature control element is in particular different from the base plate of the battery housing; preferably, it is arranged at a distance from the base plate and/or at an angle to the base plate. When using the temperature control element, it is not necessary to design the base plate to temperature control the battery cell arrangement. The base plate can therefore be designed without fluid channels. Of course, it is also possible to create a fluid channel in the base plate through which the fluid flows, at least temporarily.

Of course, only a single fluid channel can be created in the temperature control element. Preferably, however, there are multiple fluid channels in the temperature control element, which are preferably fluidically connected in parallel. The fluid flows through the multiple fluid channels simultaneously or in parallel. If in this description the at least fluid channel or the fluid channel is mentioned, the statements are always equivalent. Explanations regarding the at least one fluid channel are therefore transferable to the fluid channel and statements regarding the fluid channel are transferable to the at least one fluid channel. If there are multiple fluid channels, the explanations regarding the at least one fluid channel or the fluid channel can preferably be transferred to each of the multiple fluid channels.

The temperature control element is mechanically connected to the battery cell arrangement, namely using the holding frame. The holding frame connects the temperature control element and the battery cell arrangement; for this purpose, it engages and holds the temperature control element on the one hand and the battery cell arrangement on the other. The battery cell arrangement, the temperature control device and the holding frame together form the cell module. This is inserted into the battery housing, in particular as a component of the battery module. When assembling the traction battery, the entire cell module is preferably inserted into the battery housing, meaning that the battery cell arrangement, the temperature control device and the holding frame connecting them are inserted together into the battery housing.

Over time, the battery cell array may expand, particularly during charging or discharging of the traction battery. This expansion can also be called “swelling”. To counteract this expansion, the battery cell arrangement is usually mechanically braced. For this purpose, the battery cell arrangement is subjected to a clamping force using the clamping device, which applies a contact pressure to the battery cell arrangement that opposes its expansion. The clamping force counteracts an expansion force exerted on the clamping device by the expansion of the battery cell arrangement. To clamp the battery cell arrangement, the clamping device engages the end plates located on opposite sides of the battery cell arrangement and exerts the clamping force on them. The end plates are therefore pushed towards each other by the clamping force, and the battery cell arrangement is subjected to the clamping force by the clamping device via the end plates.

The clamping device comprises, for example, a metal band which is arranged around the battery cell arrangement in the open state and is subsequently closed and then tensioned in order to effect the clamping force. It can also be provided that the clamping device has a circumferentially closed clamping band, which is arranged around the battery cell arrangement in the circumferentially closed state. In particular, for this purpose, the battery cell arrangement is compressed and thereby prestressed by applying a prestressing force, the circumferentially closed clamping band is arranged around the battery cell arrangement and the prestressing of the battery cell arrangement is subsequently terminated with the prestressing force.

The expansion of the battery cell arrangement and the resulting dimensional change of the battery cell arrangement can lead to a deterioration of the heat transfer between the battery cell arrangement and the temperature control element. In order to achieve a particularly reliable and permanent thermal connection between the temperature control element and the battery cell arrangement, the heat conducting means is therefore inserted between the temperature control element and the battery cell arrangement. The temperature control element is thermally coupled to the battery cell arrangement via the heat conducting means; for this purpose, the heat conducting means is accommodated between the temperature control element and the battery cell arrangement and lies on the one hand against the temperature control element and on the other hand against the battery cell arrangement, in particular in a planar manner. With the help of the heat transfer medium, the thermal connection between the battery cell arrangement and the temperature control element can be maintained and thus ensured even in the event of significant dimensional changes in the battery cell arrangement.

A further development of the invention provides that the temperature control element has a fluid inlet connection and a fluid outlet connection which are fluidically connected to one another via the at least one fluid channel, wherein the at least one fluid channel runs continuously straight between the fluid inlet connection and the fluid outlet connection and/or the temperature control element has a continuously constant cross-section between the fluid inlet connection and the fluid outlet connection. The fluid inlet connection and the fluid outlet connection are located on the temperature control element, for example they are designed as an opening, which is created by a surface of the temperature control element passing through the fluid channel.

The fluid inlet connection and the fluid outlet connection are preferably arranged on opposite sides of the temperature control element. The fluid is supplied to the temperature control element through the fluid inlet connection and the fluid is removed again through the fluid outlet connection. In terms of flow, there is at least one fluid channel between the fluid inlet connection and the fluid outlet connection. In the case of a plurality of fluid channels, it can be provided that each of the fluid channels starts fluidically from the fluid inlet connection and extends fluidically to the fluid outlet connection, so that the fluid inlet connection and the fluid outlet connection are fluidically connected to one another in parallel via the plurality of fluid channels.

In a first variant of the cell module or the traction battery, the at least one fluid channel runs continuously straight, namely from the fluid inlet connection to the fluid outlet connection. Additionally or alternatively, according to a second variant, the cross section of the temperature control element is continuously the same between the fluid inlet connection and the fluid outlet connection. The two variants can be combined. They each enable particularly simple production of the temperature control element and low pressure loss across the fluid channel.

A further development of the invention provides that the fluid inlet connection and/or the fluid outlet connection is fluidically connected to a fluid line produced in the holding frame. The fluid line is located in the holding frame, for example it completely penetrates the holding frame in at least one direction. It is fluidically connected to the fluid inlet connection or the fluid outlet connection.

For example, it is provided to supply the fluid to the fluid inlet connection via the fluid line and/or to discharge the fluid from the fluid outlet connection via the fluid line. Particularly preferably, a plurality of fluid lines are configured in the holding frame, wherein a first of the fluid lines is fluidically connected to the fluid inlet connection and a second of the fluid lines is fluidically connected to the fluid outlet connection. Such a design enables a particularly simple and reliable supply of the fluid to the temperature control element or the fluid channel.

A further development of the invention provides that the temperature control element is designed as an extruded profile. In particular, the at least one fluid channel is a component of the extruded profile, i.e., it is produced during extrusion of the temperature control element. This enables particularly simple and cost-effective production of the temperature control element.

A further development of the invention provides that the temperature control element is arranged on the one side and the battery cell arrangement on the other side of the holding frame. In other words, the temperature control element and the battery cell arrangement are arranged on opposite sides of the holding frame or engage the holding frame from opposite sides. This results in a particularly compact and stable design of the cell module.

A further development of the invention provides that the heat conducting means is arranged in a passage recess of the holding frame and/or thermally bridges the passage recess. The passage recess is made in the holding frame and extends completely through the holding frame in one direction. Preferably, the passage recess is completely encompassed by the holding frame in one direction, so the holding frame forms an edge which completely and continuously encompasses the passage recess. For example, the battery cell arrangement on the one hand and the temperature control element on the other hand are arranged in the passage recess. Accordingly, the heat conducting means is present in the passage recess and bridges it, so that the battery cell arrangement and the temperature control element are reliably thermally coupled to one another via the heat conducting means present in the passage recess.

If the battery cell arrangement has a plurality of battery cells, the holding frame preferably has a plurality of passage recesses, in particular a passage recess for each of the plurality of battery cells. Each of the passage recesses is overlapped by one of the battery cells, preferably completely covered and/or closed by it. It may be provided that the passage recess is at least as large as the battery cell arranged in overlap with it; however, it is preferably slightly smaller, so that the battery cell is supported at least in some regions, in particular continuously and uninterruptedly, on the edge delimiting the passage recess. For example, the passage recess has a surface area which is at least 80%, at least 90% or at least 95% of a surface area of a side surface of the battery cell which faces the passage recess of the holding frame. The described design allows both a reliable holding of the battery cell arrangement on the holding frame and an efficient temperature control using the temperature control element.

A further development of the invention provides that the heat conducting means is present as a thermal pad or as a thermal paste. The thermal pad is understood to mean, in particular, a flexible, heat conducting element that is arranged between the battery cell arrangement and the temperature control element. The thermal pad is preferably self-adhesive, i.e. provided with an adhesive layer. For example, the thermal interface is self-adhesive on one side only or self-adhesive on both sides. In the first case, the thermal pad is glued to the battery cell arrangement or the temperature control element, whereas it merely rests on the other component. In the latter case, the thermal pad is glued to both the battery cell arrangement and the temperature control element. Alternatively, the heat conducting means is available in the form of thermal paste. Thermal paste is a viscous, heat conducting material. For example, the thermal paste contains silicone. This has the advantage that when the thermal paste is exposed to heat during operation of the traction battery, ceramification occurs.

A further development of the invention provides that the heat conducting means is present with different layer thicknesses between the temperature control element and the battery cell arrangement, in particular is applied in spaced-apart regions. In different regions, the heat conducting means therefore has different layer thicknesses, preferably independent of the distance between the battery cell arrangement and the temperature control element. For example, it is intended to apply the heat conducting means with different layer thicknesses, either to the temperature control element or to the battery cell arrangement, before the temperature control element and the battery cell arrangement are arranged together.

The different layer thicknesses differ, for example, by at least 20%, at least 30% or at least 40%. One of the layer thicknesses can also be zero. For example, the heat conducting means is applied in a first region with a certain layer thickness that is different from zero, but a second region adjacent to this first region is free of heat conducting means, i.e. there is no heat conducting means in it. For example, the second region is enclosed by a plurality of first regions which are located on opposite sides of the second region. For example, a distance between the first regions is at least 10%, at least 30% or at least 50% of an extension of one of the first regions in the same direction. This achieves a particularly targeted adjustment of the heat transfer between the battery cell arrangement and the temperature control element.

A further development of the invention provides that the cell module is a first cell module, the battery cell arrangement is a first battery cell arrangement and the temperature control element is a first temperature control element and in addition to the first cell module there is a second cell module with a second battery cell arrangement and a second temperature control element, wherein the second temperature control element is arranged on a side of the first battery cell arrangement opposite the first temperature control element and is thermally coupled to the first battery cell arrangement via additional heat conducting means.

The traction battery has multiple cell modules, namely at least the first cell module and the second cell module. In principle, any number of such cell modules can be present, with two of the cell modules being adjacent to each other, i.e. arranged next to each other. For example, the cell modules are directly adjacent to one another, meaning they are arranged directly next to one another.

Each of the cell modules has a battery cell arrangement, a temperature control element and a holding frame, wherein the respective battery cell arrangement and the respective temperature control element are connected to one another, in particular fastened to one another, via the respective holding frame. It can be provided that the holding frames of the cell modules are designed as a common holding frame, i.e. that the holding frames are manufactured in one piece and/or from the same material. The holding frames can of course also be available separately from each other.

The cell modules are preferably designed identically to one another. The plurality of cell modules together form the aforementioned battery module; accordingly, they are preferably arranged together between two end plates and clamped together by means of the clamping device. At least one such battery module is arranged in the battery housing of the traction battery.

At least one of the battery cell arrangements of the cell modules is arranged between two temperature control elements of the cell modules and is thermally coupled to them on opposite sides by means of a heat conducting means. The temperature control element of the first cell module is located on a first side of the battery cell arrangement and the temperature control element of the second cell module is located on a second side of the battery cell arrangement. The battery cell arrangement is thermally connected to both with a heat conducting means. Such an arrangement enables particularly effective temperature control of the battery cell arrangement or of the multiple battery cell arrangements.

A further development of the invention provides that the cell module has a second temperature control element arranged at a distance from the temperature control element present as the first temperature control element, wherein a deformable compensation element is arranged between the first temperature control element and the second temperature control element. The temperature control element is referred to as the first temperature control element and in addition to this there is the second temperature control element. The second temperature control element is preferably designed identically to the first temperature control element. It is part of the same cell module, i.e. it is also arranged on the holding frame, in particular held on the holding frame. Particularly preferably, the temperature control elements are mounted displaceably on the holding frame, in particular in a direction running through the compensation element and/or perpendicular to a center plane of the compensation element.

The two temperature control elements are arranged in such a way that a gap is created between them, particularly when viewed in section. The compensation element is located in the gap so that the compensation element at least partially fills the gap. Preferably, the compensation element rests on the one hand on the first temperature control element and on the other hand on the second temperature control element, so that the temperature control elements accommodate the compensation element between them.

The compensation element is deformable, in particular elastically deformable. This allows the temperature control elements to be displaced relative to one another, particularly by deforming the compensation element. The compensation element has an elasticity that is greater than that of the temperature control elements; for example, the compensation element consists of an elastomer, in particular rubber. The compensation element alternatively consists of a foam, preferably a plastic foam. The foam is, for example, open-pored or closed-pored.

Preferably, battery cell arrangements are arranged on opposite sides of the temperature control elements. In this respect, the battery cell arrangement referred to as the first battery cell arrangement is located on the first temperature control element and a second battery cell arrangement is located on the second temperature control element. The first battery cell arrangement is arranged on the side of the first temperature control element facing away from the second battery cell arrangement, and the second battery cell arrangement is arranged on the side of the second temperature control element facing away from the first battery cell arrangement.

The second battery cell arrangement is, for example, part of a second cell module which is adjacent to the cell module referred to as the first cell module. In this respect, the second battery cell arrangement does not also lie against the first temperature control element, but against the second temperature control element arranged at a distance therefrom. Particularly preferably, the second battery cell arrangement is thermally connected to the second temperature control element via heat conducting means. On the one hand, this achieves particularly effective temperature control of the battery cell arrangements. On the other hand, a compensatory movement of the battery cell arrangements, in particular caused by their expansion, is permitted.

The invention further relates to a method for producing a traction battery, in particular a traction battery according to the embodiments within the scope of this description, wherein the traction battery has a cell module comprising a battery cell arrangement and a temperature control device for temperature control of the battery cell arrangement. It is provided that the temperature control device has a temperature control element having at least one fluid channel, which is connected to the battery cell arrangement by means of a holding frame of the cell module, is inserted together with the battery cell arrangement into a battery housing of the traction battery and is thermally coupled to the battery cell arrangement via a heat conducting means.

The advantages of such a procedure or such an embodiment of the traction battery have already been discussed. Both the traction battery and the method for its production can be developed further according to the statements made in the context of the present description.

The features and feature combinations described in the description, in particular the features and feature combinations described below in the description of the figures and/or shown in the figures may be used not only in the respective specified combination, but also in other combinations or alone, without departing from the scope of the invention. The invention should therefore also be considered to comprise embodiments that are explicitly not shown or explained in the description and/or the figures, but emerge from the explained embodiments or can be derived from them.

### BRIEF DESCRIPTION OF THE FIGURES

In the following, the invention will be explained in greater detail with reference to the exemplary embodiments depicted in the drawings, without this restricting the invention. In particular:

FIG. 1 shows a schematic illustration of a part of a traction battery for a motor vehicle, namely a cell module having a battery cell arrangement and a temperature control device,

FIG. 2 shows a schematic sectional view of the cell module, showing a heat conducting means present between the temperature control device and the battery cell arrangement.

### DETAILED DESCRIPTION

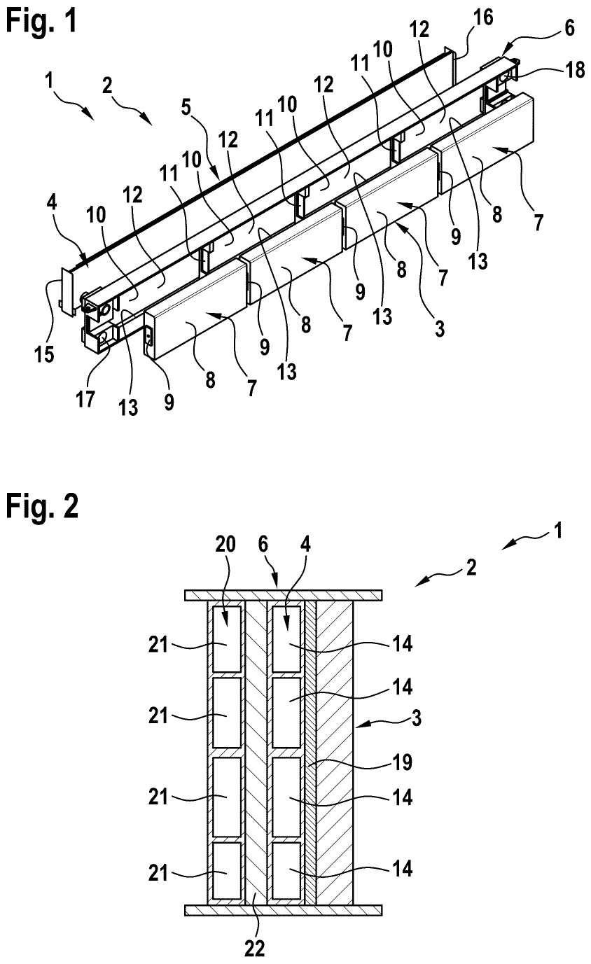

FIG. 1 shows a schematic representation of a part of a traction battery 1 for a motor vehicle, namely a cell module 2 of the traction battery 1 in an exploded view. The cell module 2 has a battery cell arrangement 3, a temperature control element 4 of a temperature control device 5 and a holding frame 6. In the illustrated embodiment, the battery cell arrangement 3 has multiple battery cells 7, which are present as prismatic battery cells. The battery cells 7 each have a cell housing 8 on which electrodes 9 are arranged on the front side. The electrodes 9 of battery cells 7 arranged adjacent to one another, which are only partially visible here, are electrically connected to one another, for example they lie against one another for this purpose.

It can be seen that the battery cells 7 or their cell housings 8 have a length in a first direction, a height in a second direction and a width in a third direction, wherein the three directions are each perpendicular to one another and accordingly define a Cartesian coordinate system. For each battery cell 7, its length is greater than its height, which in turn is greater than its width. The battery cells 7 are arranged adjacent to one another in the first direction, so that a height of the battery cell arrangement 3 corresponds to the height of one of the battery cells 7 and a width of the battery cell arrangement 3 corresponds to a width of one of the battery cells 7. The length of the battery cell arrangement 3, however, corresponds to a multiple of the length of the battery cells 7. In other words, the battery cells are arranged in a row in the first direction to form the battery cell arrangement 3.

The battery cell arrangement 3 is arranged on the holding frame 6, in particular it is at least partially or even completely accommodated therein. For this purpose, the holding frame 6 preferably has a plurality of receptacles 10 which are separated from one another by webs 11. In the direction of the temperature control element 4, the holding frame 6 is completely penetrated, in particular by a passage recess 12 adjoining each of the receptacles 10. Each of the passage recesses 12 is encompassed by an edge 13 which is formed by the holding frame 6. For example, the battery cells 7 are supported at least in part on the edge 13.

The temperature control element 4 is arranged on a side of the holding frame 6 opposite the battery cell arrangement 3. This is preferably in the form of an extruded profile and has at least one fluid channel 14 (not visible here), which is fluidically connected to a first fluid distributor 15 and to a second fluid distributor 16. Via the fluid distributors 15 and 16, the fluid channel 14 is connected to fluid lines 17 and 18, which are formed in the holding frame 6. The fluid channels 14 of the temperature control element 4 of adjacent cell modules 2 are fluidically connected to one another via the fluid lines 17 and 18.

FIG. 2 shows a sectional view through the region of the traction battery 1, namely through the cell module 2. On the one hand, it can be seen that the temperature control element 4 has a plurality of fluid channels 14, which preferably each have the same flow cross-section. The fluid channels 14 are preferably produced by extrusion of the temperature control element 4. On the other hand, it can be seen that a heat conducting means 19 is present between the temperature control element 4 and the battery cell arrangement 3. The battery cell arrangement 3 and the temperature control element 4 are thermally coupled to one another via the heat conducting means 19. The heat conducting means 19 preferably bridges the passage recess 12 of the holding frame 6, so that despite the arrangement of the battery cell arrangement 3 in the holding frame 6, a reliable and effective temperature control of the battery cell arrangement 3 can always be carried out by means of the temperature control element 4 or the temperature control device 5.

Optionally, the temperature control element 4 is present as a first temperature control element 4, and in addition to the first temperature control element 4, a second temperature control element 20 is part of the temperature control device 5. The second temperature control element 20 is preferably designed analogously to the first temperature control element 4; in this respect, it has one or more fluid channels 21. A compensation element 22 is arranged between the temperature control elements 4 and 20. This is deformable, preferably elastically deformable. This allows compensation for dimensional changes in the battery cell arrangement 3. Preferably, a further battery cell arrangement (not shown here) is located on the second temperature control element 20 for temperature control.

### LIST OF REFERENCE NUMERALS

1 traction battery
2 cell module
3 battery cell arrangement
4 temperature control element
5 temperature control device
6 holding frame
7 battery cells
8 cell housing
9 electrodes
10 receptacle
11 bridge
12 passage recess
13 edge
14 fluid channel
15 1. fluid distributor
16 2. fluid distributor
17 fluid line
18 fluid line
19 heat conducting means
20 2. temperature control element
21 fluid channel
22 compensation element

1. A traction battery for a motor vehicle, comprising a cell module having a battery cell arrangement and a temperature control device for temperature control of the battery cell arrangement, wherein the temperature control device has a temperature control element having at least one fluid channel, which is connected to the battery cell arrangement by a holding frame of the cell module, is inserted together with the battery cell arrangement into a battery housing of the traction battery and is thermally coupled to the battery cell arrangement via a heat conducting means.

2. The traction battery according to claim 1, wherein the temperature control element has a fluid inlet connection and a fluid outlet connection which are fluidically connected to one another via the at least one fluid channel, wherein the at least one fluid channel runs continuously straight between the fluid inlet connection and the fluid outlet connection and/or the temperature control element has a continuously constant cross-section between the fluid inlet connection and the fluid outlet connection.

3. The traction battery according to claim 2, wherein the fluid inlet connection and/or the fluid outlet connection is fluidically connected to a fluid line formed in the holding frame.

4. The traction battery according to claim 1, wherein the temperature control element is designed as an extruded profile.

5. The traction battery according to claim 1, wherein the temperature control element is arranged on the one side and the battery cell arrangement on the other side of the holding frame.

6. The traction battery according to claim 1, wherein the heat conducting means is arranged in a passage recess of the holding frame and/or thermally bridges the passage recess.

7. The traction battery according to claim 1, wherein the heat conducting means is present with different layer thicknesses between the temperature control element and the battery cell arrangement.

8. The traction battery according to claim 1, wherein the cell module is a first cell module, the battery cell arrangement is a first battery cell arrangement and the temperature control element is a first temperature control element and in addition to the first cell module there is a second cell module with a second battery cell arrangement and a second temperature control element, wherein the second temperature control element is arranged on a side of the first battery cell arrangement opposite the first temperature control element and is thermally coupled to the first battery cell arrangement via additional heat conducting means.

9. The traction battery according to claim 1, wherein the cell module has a second temperature control element arranged at a distance from the temperature control element present as the first temperature control element, wherein a deformable compensation element is arranged between the first temperature control element and the second temperature control element.

10. A method for producing a traction battery, in particular a traction battery according to claim 1, wherein the traction battery has cell module having a battery cell arrangement and a temperature control device for temperature control of the battery cell arrangement, wherein the temperature control device has a temperature control element having at least one fluid channel, which is connected to the battery cell arrangement by a holding frame of the cell module, is inserted together with the battery cell arrangement into a battery housing of the traction battery and is thermally coupled to the battery cell arrangement via a heat conducting means.

11. The traction battery according claim 2, wherein the temperature control element is designed as an extruded profile.

12. The traction battery according claim 3, wherein the temperature control element is designed as an extruded profile.

13. The traction battery according to claim 2, wherein the temperature control element is arranged on the one side and the battery cell arrangement on the other side of the holding frame.

14. The traction battery according to claim 3, wherein the temperature control element is arranged on the one side and the battery cell arrangement on the other side of the holding frame.

15. The traction battery according to claim 4, wherein the temperature control element is arranged on the one side and the battery cell arrangement on the other side of the holding frame.

16. The traction battery according to claim 2, wherein the heat conducting means is arranged in a passage recess of the holding frame and/or thermally bridges the passage recess.

17. The traction battery according to claim 3, wherein the heat conducting means is arranged in a passage recess of the holding frame and/or thermally bridges the passage recess.

18. The traction battery according to claim 4, wherein the heat conducting means is arranged in a passage recess of the holding frame and/or thermally bridges the passage recess.

19. The traction battery according to claim 5, wherein the heat conducting means is arranged in a passage recess of the holding frame and/or thermally bridges the passage recess.

20. The traction battery according to claim 2, wherein the heat conducting means is present with different layer thicknesses between the temperature control element and the battery cell arrangement.
